(19) United States
(12) Patent Application Publication
(10) Pub. No.: US 2026/0322118 A1
(43) Pub. Date: Oct. 15, 2026

(54) PHOTOVOLTAIC ENERGY STORAGE GRID-FORMING CONTROL METHOD, SYSTEM, DEVICE, AND STORAGE MEDIUM

(71) Applicant: TSINGHUA UNIVERSITY, Beijing (CN)

(72) Inventors: Wenchuan WU, Beijing (CN); Zizhen GUO, Beijing (CN); Haotian LIU, Beijing (CN); Hongbin SUN, Beijing (CN)

(21) Appl. No.: 19/318,421

(22) Filed: Sep. 4, 2025

(30) Foreign Application Priority Data
Dec. 27, 2024 (CN) 202411950665.9

(51) Int. Cl. H02J 3/0014; G05B 17/02; H02J 3/32; H02J 3/38; H02J 101/24; H02J 103/30

(52) U.S. Cl. CPC H02J 3/00142; G05B 17/02; H02J 3/32; H02J 3/38; H02J 2101/24; H02J 2103/30

(57) ABSTRACT

The present disclosure relates to the field of power technologies and discloses a photovoltaic energy storage grid-forming control method, system, device, and a storage medium. The method includes: establishing a full-state oscillator model, and generating, by means of the full-state oscillator model, internal potential of a photovoltaic energy storage grid-forming power supply; establishing a phase angle adaptive model, and correcting, by means of the phase angle adaptive model, the internal potential of the photovoltaic energy storage grid-forming power supply; and establishing a current inner-loop control model, and controlling, by means of the current inner-loop control model, stable operation of photovoltaic energy storage grid-forming based on corrected internal potential of the photovoltaic energy storage grid-forming power supply.

### CROSS-REFERENCE TO RELATED APPLICATIONS

This application claims priority to Chinese patent application No. 202411950665.9, filed with China National Intellectual Property Administration on Dec. 27, 2024, the entire disclosure of which is incorporated herein by reference.

### FIELD

The present disclosure relates to the field of power technologies, and more particularly, to a photovoltaic energy storage grid-forming control method, system, device, and a storage medium.

### BACKGROUND

Grid-forming control technology is a voltage-source control strategy. Conventional grid-following control allows a photovoltaic energy storage system only to track an alternating current voltage signal from the power grid to provide synchronous current injection. Under weak grid conditions, the weak synchronization characteristic of the grid-following control limits an ability of new energy to be connected to and transmitted through the grid and leads to more severe fluctuations in the frequency and voltage of the regional power grid, making it difficult to ensure the operational stability and economic efficiency of a new power system characterized by high penetration of new energy.

In the existing grid-forming control, a virtual oscillator control strategy has good grid-forming characteristic with approximately global asymptotic synchronization stability compared with the electrical characteristics of conventional synchronous machines. However, a conventional overcurrent constraint algorithm used in the existing virtual oscillator control method faces a risk of direct current voltage instability when a phase angle of a voltage of the power grid suddenly changes and lacks the voltage source support characteristic under large disturbances. During actual operation, when a micro-grid containing a plurality of grid-forming power sources is connected to the main grid from off-grid operation or when a reclosing occurs after a line fault, it causes a sudden change in a phase of the grid-connected voltage of the photovoltaic energy storage system, resulting in problems of overcurrent in the grid-connected inverter and direct current voltage surges.

### SUMMARY

Embodiments of the present disclosure provide a photovoltaic energy storage grid-forming control method, system, device, and a storage medium to solve or alleviate one or more of the above-described technical problems in the related art.

According to an aspect of the present disclosure, a photovoltaic energy storage grid-forming control method is provided. The method includes: establishing a full-state oscillator model, and generating, by means of the full-state oscillator model, internal potential of a photovoltaic energy storage grid-forming power supply; establishing a phase angle adaptive model, and correcting, by means of the phase angle adaptive model, the internal potential of the photovoltaic energy storage grid-forming power supply; and establishing a current inner-loop control model, and controlling, by means of the current inner-loop control model, stable operation of photovoltaic energy storage grid-forming based on corrected internal potential of the photovoltaic energy storage grid-forming power supply.

In a possible implementation, expressions of the full-state oscillator model are:

$$\frac{d}{dt} {v}_{o} = {ω}_{o} {Jv}_{o} + η ( {Kv}_{o} - R ( κ ) {i}_{o} + μϕ ( {v}_{m} , {v}_{dc} ) {v}_{o} ) ; \qquad ( 1 )$$

$$K = \frac{1}{{{v}_{m}^{*}}^{2}} R ( κ ) [ \begin{matrix}{p}^{*} & {q}^{*} \\ - {q}^{*} & {p}^{*}\end{matrix} ] ; \qquad ( 2 )$$

$${ω}_{o} = {ω}_{n} + λ \cdot sin ( κ ) ( {v}_{dc} - {v}_{dc}^{*} ) + Δ {ω}_{oc} ; \qquad ( 3 )$$

$$ϕ ( {v}_{m} , {v}_{dc} ) = \frac{{v}_{m}^{*} - {v}_{m}}{{v}_{m}^{*}} + \frac{λ}{ημ} cos κ ( {v}_{dc} - {v}_{dc}^{*} ) ; \qquad ( 4 )$$

$$κ = {tan}^{- 1} ( {X}_{θ} / {R}_{θ} ) ; \qquad ( 5 )$$

$$R ( θ ) = [ \begin{matrix}cos θ & - sin θ \\ sin θ & cos θ\end{matrix} ] ; \qquad ( 6 )$$

where: a vector νₐ=[νₐₒ, ν_{αβ}]^{T} represents a voltage of an oscillator, and νₐₒ and ν_{αβ} represent α-axis and β-axis components of the voltage of the oscillator, respectively; a vector iₐ=[iₐₒ i_{αβ}]^{T} represents an output current at a grid connection point, and iₐₒ and i_{αβ} represent α-axis and β-axis components of the output current at the grid connection point, respectively; ν_{dc} represents a voltage of a photovoltaic array or an energy storage battery at a direct current side; Δω_{oc} represents a phase angle adaptive correction value; R_{g} represents grid-connected resistance; X₀ represents grid-connected reactance; θ represents a phase angle of the voltage of the oscillator; φ(νₘ, ν_{dc}) represents a control function of a voltage amplitude; K represents a power reference matrix; ωₒ represents a frequency setting value of the oscillator; η represents an active synchronization control parameter; μ represents an amplitude control parameter; λ represents a direct current voltage control parameter; νₘ=∥νₒ∥ represents an alternating current voltage amplitude, an operator ∥·∥ representing an Euclidean norm; p*, q*,

$${v}_{dc}^{*} , and {v}_{m}^{*}$$

represent setting values of active power, reactive power, a direct current voltage amplitude, and the alternating current voltage amplitude, respectively; ωₙ represents a rated frequency of a power grid; K represents a line impedance parameter angle; J=R(π/2) is defined; and a matrix R represents a two-dimensional rotation matrix.

In a possible implementation, expressions of the phase angle adaptive model are:

$${i}_{f}^{*} = {Y}_{α β} \cdot ( {v}_{o} - {v}_{f} ) ; \qquad ( 7 )$$

$${Y}_{α β} = {Z}_{vi}^{- 1} = {[ \begin{matrix}{R}_{v} & - {ω}_{n} {L}_{v} \\ {ω}_{n} {L}_{v} & {R}_{v}\end{matrix} ]}^{- 1} ; \qquad ( 8 )$$

$${i}_{lim}^{*} = \{ \begin{matrix}{i}_{f}^{*} & ‖ {i}_{f}^{*} ‖ ⩽ {I}_{max} \\ \frac{{I}_{max}}{‖ {i}_{f}^{*} ‖} {i}_{f}^{*} & ‖ {i}_{f}^{*} ‖ > {I}_{max}\end{matrix} ; \qquad ( 9 )$$

$$Δ {i}^{*} = ‖ {i}_{f}^{*} ‖ - ‖ {i}_{lim}^{*} ‖ ; \qquad ( 10 )$$

$${ω}_{oc} = {k}_{oc} Δ {i}^{*} {v}_{fq} ; \qquad ( 11 )$$

$$[ \begin{matrix}{v}_{fd} \\ {v}_{iq}\end{matrix} ] = [ \begin{matrix}cos ( θ ) & sin ( θ ) \\ - sin ( θ ) & cos ( θ )\end{matrix} ] [ \begin{matrix}{v}_{f α} \\ {v}_{f β}\end{matrix} ] ; \qquad ( 12 )$$

$$where : {i}_{f}^{*}$$

represents an intermediate variable of an inverter current instruction; Y_{αβ} represents an inverse matrix of a virtual impedance matrix Z_{νi}; a vector νₒ=[νₒₐ ν_{αβ}]^{T} represents a voltage of an oscillator; a vector ν_{f}=[ν_{fα}, ν_{fβ}]^{T} represents a voltage measurement at a grid connection point, and νf_{α} and ν_{fβ} represent α-axis and β-axis components of a voltage at the grid connection point, respectively; R_{ν} and L_{ν} represent virtual resistance and virtual inductance, respectively; ωₙ represents a rated frequency of a power grid; a vector

$${i}_{lim}^{*}$$

represents the inverter current instruction; Iₘₐₓ represents a maximum value of an overcurrent constraint; Δi* represents a degree of the overcurrent constraint; Δω_{oc} represents a phase angle adaptive correction value; k_{oc} represents a phase angle adaptive parameter; ν_{fq} represents a q-axis component of the voltage at the grid connection point; ν_{fd} represents a d-axis component of the voltage at the grid connection point; and θ represents a phase angle of the voltage of the oscillator.

In a possible implementation, expressions of the current inner-loop control model are:

$$\frac{d}{dt} ξ = {ω}_{o} J ξ + {i}_{lim}^{*} - {i}_{f} ; \qquad ( 13 )$$

$${v}_{i} = {k}_{p} ( {i}_{lim}^{*} - {i}_{f} ) + {k}_{r} ξ + {v}_{f} + {ω}_{o} {L}_{f} {Ji}_{f} ; \qquad ( 14 )$$

where: ξ represents an integral variable of a proportional resonant controller, ωₒ represents a frequency setting value of an oscillator; a vector

$${i}_{lim}^{*}$$

represents an inverter current instruction; a vector i_{f}=[iⱼₒ i_{jβ}]^{T} represents an output current of an inverter, and i_{fα}, and i_{fβ} represent α-axis and β-axis components of the output current of the inverter, respectively; kₚ and kᵣ represent a proportional control parameter and a resonant integral control parameter, respectively; a vector ν=[ν_{fα}, ν_{fβ}]^{T} represents a voltage measurement at a grid connection point, and ν_{fα} and ν_{fβ} represent α-axis and β-axis components of the voltage at the grid connection point, respectively; L_{f} represents a filter inductance; J=R(π/2) is defined; and a matrix R is a two-dimensional rotation matrix.

According to an aspect of the present disclosure, a photovoltaic energy storage grid-forming control system is provided. The system includes: a first establishment unit configured to establish a full-state oscillator model and generate, by means of the full-state oscillator model, internal potential of a photovoltaic energy storage grid-forming power supply; a second establishment unit configured to establish a phase angle adaptive model and correct, by means of the phase angle adaptive model, the internal potential of the photovoltaic energy storage grid-forming power supply; and a third establishment unit configured to establish a current inner-loop control model and control, by means of the current inner-loop control model, stable operation of photovoltaic energy storage grid-forming based on corrected internal potential of the photovoltaic energy storage grid-forming power supply.

In a possible implementation, expressions of the full-state oscillator model are:

$$\frac{d}{dt} {v}_{o} = {ω}_{o} {Jv}_{o} + η ( {Kv}_{o} - R ( κ ) {i}_{o} + μϕ ( {v}_{m} , {v}_{dc} ) {v}_{o} ) ; \qquad ( 1 )$$

$$K = \frac{1}{{{v}_{m}^{*}}^{2}} R ( κ ) [ \begin{matrix}{p}^{*} & {q}^{*} \\ - {q}^{*} & {p}^{*}\end{matrix} ] ; \qquad ( 2 )$$

$${ω}_{o} = {ω}_{n} + λ \cdot sin ( κ ) ( {v}_{dc} - {v}_{dc}^{*} ) + Δ {ω}_{oc} ; \qquad ( 3 )$$

$$ϕ ( {v}_{m} , {v}_{dc} ) = \frac{{v}_{m}^{*} - {v}_{m}}{{v}_{m}^{*}} + \frac{λ}{ημ} cos κ ( {v}_{dc} - {v}_{dc}^{*} ) ; \qquad ( 4 )$$

$$κ = {tan}^{- 1} ( {X}_{θ} / {R}_{θ} ) ; \qquad ( 5 )$$

$$R ( θ ) = [ \begin{matrix}cos θ & - sin θ \\ sin θ & cos θ\end{matrix} ] ; \qquad ( 6 )$$

where: a vector ν_{α}=[ν_{oα}ν_{oβ}]^{T} represents a voltage of an oscillator, and ν_{oα} and ν_{oβ} represent α-axis and β-axis components of the voltage of the oscillator, respectively; a vector iₒ=[i_{oα}, i_{oβ}]^{T} represents an output current at a grid connection point, and i_{oα} and i_{oβ} represent α-axis and β-axis components of the output current at the grid connection point, respectively; ν_{dc} represents a voltage of a photovoltaic array or an energy storage battery at a direct current side; Δω_{oc} represents a phase angle adaptive correction value; R_{g} represents grid-connected resistance; X represents grid-connected reactance; θ represents a phase angle of the voltage of the oscillator; φ(νₘ, ν_{dc}) represents a control function of a voltage amplitude; K represents a power reference matrix; ωₒ represents a frequency setting value of the oscillator; η represents an active synchronization control parameter; μ represents an amplitude control parameter; λ represents a direct current voltage control parameter; νₘ=∥νₒ∥ represents an alternating current voltage amplitude, an operator ∥·∥ representing an Euclidean norm; p*, q*,

$${v}_{dc}^{*} , and {v}_{m}^{*}$$

represent setting values of active power, reactive power, a direct current voltage amplitude, and the alternating current voltage amplitude, respectively; ωₙ represents a rated frequency of a power grid; K represents a line impedance parameter angle; J=R(π/2) is defined; and a matrix R represents a two-dimensional rotation matrix.

In a possible implementation, expressions of the phase angle adaptive model are:

$${i}_{f}^{*} = {Y}_{α β} \cdot ( {v}_{o} - {v}_{f} ) ; \qquad ( 7 )$$

$${Y}_{α β} = {Z}_{vi}^{- 1} = {[ \begin{matrix}{R}_{v} & - {ω}_{n} {L}_{v} \\ {ω}_{n} {L}_{v} & {R}_{v}\end{matrix} ]}^{- 1} ; \qquad ( 8 )$$

$${i}_{lim}^{*} = \{ \begin{matrix}{i}_{f}^{*} & ‖ {i}_{f}^{*} ‖ ⩽ {I}_{max} \\ \frac{{I}_{max}}{‖ {i}_{f}^{*} ‖} {i}_{f}^{*} & ‖ {i}_{f}^{*} ‖ > {I}_{max}\end{matrix} ; \qquad ( 9 )$$

$$Δ {i}^{*} = ‖ {i}_{f}^{*} ‖ - ‖ {i}_{lim}^{*} ‖ ; \qquad ( 10 )$$

$${ω}_{oc} = {k}_{oc} Δ {i}^{*} {v}_{fq} ; \qquad ( 11 )$$

$$[ \begin{matrix}{v}_{fd} \\ {v}_{iq}\end{matrix} ] = [ \begin{matrix}cos ( θ ) & sin ( θ ) \\ - sin ( θ ) & cos ( θ )\end{matrix} ] [ \begin{matrix}{v}_{f α} \\ {v}_{f β}\end{matrix} ] ; \qquad ( 12 )$$

$$where : {i}_{f}^{*}$$

represents an intermediate variable of an inverter current instruction; Y_{αβ} represents an inverse matrix of a virtual impedance matrix Zₒ; a vector νₒ=[ν_{oα} ν_{oβ}]^{T} represents a voltage of an oscillator; a vector ν_{f}=[ν_{fα} ν_{fβ}]^{T} represents a voltage measurement at a grid connection point, and ν_{fα} and ν_{fβ} represent α-axis and β-axis components of a voltage at the grid connection point, respectively; Rᵥ and Lᵥ represent virtual resistance and virtual inductance, respectively; ωₙ represents a rated frequency of a power grid; a vector

$${i}_{lim}^{*}$$

represents the inverter current instruction; Iₘₐₓ represents a maximum value of an overcurrent constraint; Δi* represents a degree of the overcurrent constraint; Δω_{oc} represents a phase angle adaptive correction value; k_{oc} represents a phase angle adaptive parameter; ν_{fq} represents a q-axis component of the voltage at the grid connection point; ν_{fd} represents a d-axis component of the voltage at the grid connection point; and θ represents a phase angle of the voltage of the oscillator.

In a possible implementation, expressions of the current inner-loop control model are:

$$\frac{d}{dt} ξ = {ω}_{o} J ξ + {i}_{lim}^{*} - {i}_{f} ; \qquad ( 13 )$$

$${v}_{i} = {k}_{p} ( {i}_{lim}^{*} - {i}_{f} ) + {k}_{r} ξ + {v}_{f} + {ω}_{o} {L}_{f} {Ji}_{f} ; \qquad ( 14 )$$

where: ξ represents an integral variable of a proportional resonant controller, ωₒ represents a frequency setting value of an oscillator; a vector

$${i}_{lim}^{*}$$

represents an inverter current instruction; a vector i_{f}=[i_{fα} i_{fβ}]^{T} represents an output current of an inverter, and i_{fα} and i_{fβ} represent α-axis and β-axis components of the output current of the inverter, respectively; kₚ and kᵣ represent a proportional control parameter and a resonant integral control parameter, respectively; a vector of νⱼ=[ν_{fα} ν_{fβ}]^{T} represents a voltage measurement at a grid connection point, and ν_{fα} and ν_{fβ} represent α-axis and β-axis components of the voltage at the grid connection point, respectively; L_{f} represents a filter inductance; J=R(π/2) is defined; and a matrix R is a two-dimensional rotation matrix.

According to an aspect of the present disclosure, a device is provided. The device includes: a processor; and a memory configured to store a computer program. The processor invokes the computer program stored in the memory to perform the above-described photovoltaic energy storage grid-forming control method.

According to an aspect of the present disclosure, a computer-readable storage medium is provided. The computer-readable storage medium has a computer program stored thereon. The computer program, when executed by a processor, allows the processor to be capable of performing the above-described photovoltaic energy storage grid-forming control method.

The present disclosure has the following beneficial effects: The present disclosure establishes the full-state oscillator model. By introducing the phase angle adaptive correction value into the frequency setting value of the oscillator, the internal potential of the grid-forming algorithm can quickly recover synchronization stability when the phase angle suddenly changes, avoiding the impact of energy exchange caused by the phase angle difference on the direct current bus capacitance and preventing the inverter from being disconnected from the power grid due to inverter overcurrent and direct current bus voltage spikes. The phase angle adaptive model is established to enhance adaptability of the inverter to sudden phase angle changes and suppress transient overcurrent that may occur during the grid-forming control process. In addition, the current inner-loop control model is established to control the stable operation of the photovoltaic energy storage grid-forming. In summary, the present disclosure can enable the photovoltaic energy storage system to provide a synchronous grid-forming characteristic for stable operation under large disturbances caused by the sudden phase angle changes, in such a manner that a micro-grid containing an extremely high proportion of new energy can achieve flexible and reliable stable operation in both grid-connected and off-grid modes.

Details of one or more embodiments of the present disclosure are set forth in the accompanying drawings and description below. Other features and advantages of the present disclosure will become apparent from the accompanying drawings. It should be understood that the above general description and the following detailed description are only exemplary and explanatory, and cannot limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure. Obviously, the drawings as described below are merely some embodiments of the present disclosure. Based on these drawings, other drawings can be obtained by those skilled in the art without paying creative efforts.

FIG. 1 is a flowchart of a photovoltaic energy storage grid-forming control method according to an exemplary embodiment of the present disclosure.

FIG. 2 is a block diagram of a principle of photovoltaic energy storage adaptive grid-forming control adapted to sudden phase angle changes according to an exemplary embodiment of the present disclosure.

FIG. 3 is a block diagram of a photovoltaic energy storage grid-forming control system according to an exemplary embodiment of the present disclosure.

FIG. 4 is a schematic structural diagram of a device according to an exemplary embodiment of the present disclosure.

### DETAILED DESCRIPTION

Exemplary embodiments will now be described in detail below with reference to the accompanying drawings. However, the exemplary embodiments can be implemented in various forms, and should not be construed as being limited to examples set forth herein. On the contrary, the exemplary embodiments are provided to facilitate thorough and comprehensive description of the present disclosure, and fully convey the concept of the exemplary embodiments to those skilled in the art. Described features, structures, or characteristics may be combined in one or more example embodiments in any suitable manner. In the following description, many specific details are provided to facilitate solid understanding of the exemplary embodiments of the present disclosure. However, it is conceivable for those skilled in the art that technical solutions of the present disclosure can be practiced without one or more specific details, or other methods, components, apparatuses, steps, etc., can be adopted. In other cases, well-known technical solutions are not illustrated or described in detail to avoid highlighting them and obscuring various aspects of the present disclosure.

In addition, the accompanying drawings are only schematic illustrations of the present disclosure and are not necessarily drawn to scale. Same reference numerals in the figures denote same or similar parts, and thus repeated description of the same reference numerals will be omitted here. Some of the block diagrams illustrated in the figures are functional entities and do not necessarily correspond to physically or logically independent entities. These functional entities may be implemented in a form of software, or in one or more hardware modules or integrated circuits, or in different networks and/or processor apparatuses and/or microcontroller apparatuses.

The flowcharts shown in the accompanying drawings are merely illustrative and do not necessarily include all steps. For example, some steps can be further decomposed, while others can be merged or partially merged. Therefore, the actual execution order may be changed according to the actual situation.

Terms “first”, “second” and the like in the specification and claims of the present disclosure as well as the above-described accompanying drawings are used to distinguish similar objects, rather than to describe a specific sequence or order. It should be understood that data used in this way may be interchanged with each other under appropriate circumstances, such that the described embodiments of the present disclosure can be implemented in a sequence other than those illustrated or described in the present disclosure.

In addition, terms “include”, “have”, and any variations thereof are intended to cover non-exclusive inclusions. For example, a process, method, system, product, or device that includes a series of steps or units is not necessarily limited to those clearly listed steps or units, and may also include other steps or units that are not clearly listed or are inherent to the process, method, product, or device.

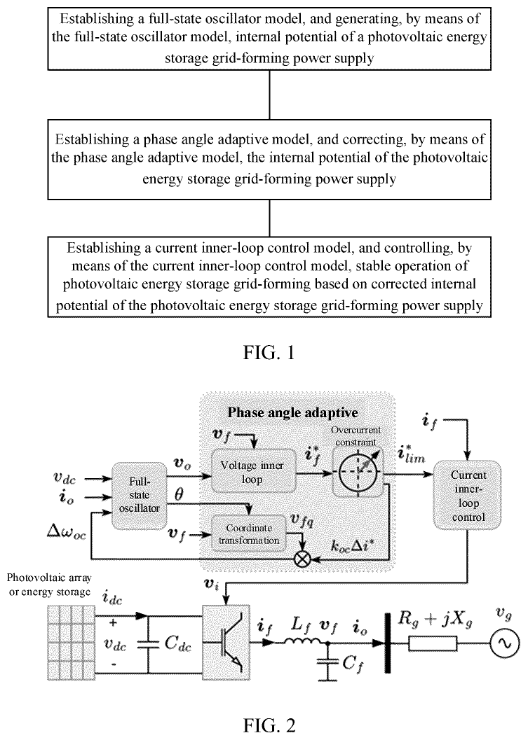

FIG. 1 is a flowchart of a photovoltaic energy storage grid-forming control method according to an exemplary embodiment of the present disclosure. As illustrated in FIG. 1, an exemplary embodiment of the present disclosure provides a photovoltaic energy storage grid-forming control method. The method includes: establishing a full-state oscillator model, and generating, by means of the full-state oscillator model, internal potential of a photovoltaic energy storage grid-forming power supply; establishing a phase angle adaptive model, and correcting, by means of the phase angle adaptive model, the internal potential of the photovoltaic energy storage grid-forming power supply; and establishing a current inner-loop control model, and controlling, by means of the current inner-loop control model, stable operation of photovoltaic energy storage grid-forming based on corrected internal potential of the photovoltaic energy storage grid-forming power supply. In an exemplary embodiment, the full-state oscillator model generates the internal potential of the photovoltaic energy storage grid-forming power supply, namely the voltage of the oscillator, based on current measurement feedback. In an exemplary embodiment, by means of the phase angle adaptive model, the phase angle adaptive correction value is output and the internal potential of the photovoltaic energy storage grid-forming power supply is corrected by the phase angle adaptive correction value, so that the internal potential of the photovoltaic energy storage grid-forming power supply can quickly recover synchronous stability when the phase angle suddenly changes. In an exemplary embodiment, the current inner loop control model outputs an inverter voltage instruction based on the corrected internal potential of the photovoltaic energy storage grid-forming power supply, and the inverter voltage instruction directly controls an inverter node voltage through a PWM signal, ensuring the stable operation of the photovoltaic energy storage grid-forming.

A photovoltaic energy storage adaptive grid-forming control method that is adapted to sudden phase angle changes provided in this embodiment mainly consists of three models: the phase angle adaptive model, the full-state oscillator model, and the current inner-loop control model. As illustrated in FIG. 2, ν_{dc} and i_{dc} represent a voltage and a current of a photovoltaic array or an energy storage battery at a direct current side, respectively, a parameter C_{dc} represents direct current bus capacitance, L_{f} and C_{f} represent filter inductance and filter capacitance, respectively, R_{g}+jX_{g} represents grid-connected impedance composed of grid-connected resistance R_{g} and grid-connected reactance X_{g}, ν_{g} represents a voltage of the power grid, a vector νₒ=[ν_{oα} ν_{oβ}]^{T} represents the voltage of the oscillator, ν_{oα} and ν_{oβ} represent α-axis and β-axis components of the voltage of the oscillator, respectively, a vector νᵢ=[ν_{iα} ν_{iβ}]^{T} represents the inverter voltage instruction, ν_{iα} and ν_{iβ} represent α-axis and β-axis components of the inverter voltage instruction, respectively, a vector ν_{f}=[ν_{fα} ν_{fβ}]^{T} represents a voltage measurement at the grid connection point, ν_{fα} and ν_{fβ} represent α-axis and β-axis components of a voltage at the grid connection point, respectively, a vector iⱼ[i_{jα} i_{jβ}]^{T} represents an output current of an inverter, i_{fα} and i_{fβ} represent α-axis and β-axis components of the output current of the inverter, respectively, a vector

$${i}_{f}^{*}$$

represents an intermediate variable of an inverter current instruction, a vector

$${i}_{lim}^{*}$$

represents the inverter current instruction, a vector iₐ=[i_{oα} i_{oβ}]^{T} represents an output current at the grid connection point, and i_{oα} and i_{oβ} represent α-axis and β-axis components of the output current at the grid connection point, respectively. θ represents a phase angle of the voltage of the oscillator, ν_{fq} represents a q-axis component of the voltage at the grid connection point, k_{oc} represents a phase angle adaptive parameter, Δi* represents a degree of overcurrent constraint; Δω_{oc} represents a phase angle adaptive correction value. The specific implementation steps are as follows:

### (1) Establishing the Full-State Oscillator Model:

The full-state oscillator model generates the internal potential of the grid-forming power supply, i.e., the voltage of the oscillator, based on current measurement feedback and is set as follows:

$$\frac{d}{dt} {v}_{o} = {ω}_{o} J {v}_{o} + η ( K {v}_{o} - R ( κ ) {i}_{o} + μϕ ( {v}_{m} , {v}_{dc} ) {v}_{o} ) ; \qquad ( 1 )$$

$$K = \frac{1}{{{v}_{m}^{*}}^{2}} R ( κ ) [ \begin{matrix}{p}^{*} & {q}^{*} \\ - {q}^{*} & {p}^{*}\end{matrix} ] ; \qquad ( 2 )$$

$${ω}_{o} = {ω}_{n} + λ \cdot sin ( κ ) ( {v}_{dc} - {v}_{dc}^{*} ) + Δ {ω}_{oc} ; \qquad ( 3 )$$

$$ϕ ( {v}_{m} , {v}_{dc} ) = \frac{{v}_{m}^{*} - {v}_{m}}{{v}_{m}^{*}} + \frac{λ}{ημ} cos κ ( {v}_{dc} - {v}_{dc}^{*} ) ; \qquad ( 4 )$$

where K represents a power reference matrix, ωₒ represents a frequency setting value of the oscillator, η represents an active synchronization control parameter, μ represents an amplitude control parameter, λ represents a direct current voltage control parameter, νₘ=∥νₑ∥ represents an alternating current voltage amplitude, and an operator ∥·∥ represents an Euclidean norm; p*, q*,

$${v}_{dc}^{*} , and {v}_{m}^{*}$$

represent setting values of active power, reactive power, a direct current voltage amplitude, and the alternating current voltage amplitude, respectively; ωₙ represents a rated frequency of a power grid; K represents a line impedance parameter angle and is defined as:

K=tan⁻¹(X_{g}/R_{g}) (5);

a matrix R represents a two-dimensional rotation matrix and is defined as:

$$R ( θ ) = [ \begin{matrix}cos θ & - sin θ \\ sin θ & cos θ\end{matrix} ] ; \qquad ( 6 )$$

and in an exemplary embodiment, J=R(π/2) is defined.

By introducing the phase angle adaptive correction value Δω_{c} into the frequency setting value ωₒ of the oscillator, the internal potential of the grid-forming algorithm can quickly recover synchronization stability when the phase angle suddenly changes, avoiding the impact of energy exchange caused by the phase angle difference on the direct current bus capacitance and preventing the inverter from being disconnected from the power grid due to inverter overcurrent and direct current bus voltage spikes. It should be noted that, the core of this method is to allow the grid-forming control algorithm to possess stronger transient stability and adaptability to large disturbances caused by sudden changes in phase angles of the power grid through adaptive adjustment of frequency. Also, this design can also be similarly adopted for conventional grid-forming control methods such as a virtual synchronous machine, droop control, and power synchronization control.

### (2) Establishing the Phase Angle Adaptive Model:

To enhance the adaptability of the inverter to sudden phase angle changes and suppress transient overcurrent that may occur during the grid-forming control process, the following phase angle adaptive method is designed. First, the voltage inner-loop control is given as follows:

$${i}_{f}^{*} = {Y}_{αβ} \cdot ( {v}_{o} - {v}_{f} ) ; \qquad ( 7 )$$

where Yₒ₃ represents an inverse matrix of a virtual impedance matrix, that is:

$${Y}_{αβ} = {Z}_{vi}^{- 1} = {[ \begin{matrix}{R}_{v} & - {ω}_{n} {L}_{v} \\ {ω}_{n} {L}_{v} & {R}_{v}\end{matrix} ]}^{- 1} ; \qquad ( 8 )$$

where Rₑ and Lᵥ represent virtual resistance and virtual inductance, respectively, which are used to adjust the small-disturbance stability and harmonic suppression characteristic of the grid-forming control.

The intermediate variable

$${i}_{f}^{*}$$

of the inverter current instruction is limited:

$${i}_{lim}^{*} = \{ \begin{matrix}{i}_{f}^{*} & ‖ {i}_{f}^{*} ‖ ⩽ {I}_{max} \\ \frac{{I}_{max}}{‖ {i}_{f}^{*} ‖} {i}_{f}^{*} & ‖ {i}_{f}^{*} ‖ > {I}_{max}\end{matrix} ; \qquad ( 9 )$$

where the vector

$${i}_{lim}^{*}$$

represents the inverter current instruction, and Iₘₐₓ represents a maximum value of an overcurrent constraint. The degree of the overcurrent constraint Δi* is defined as:

$$Δ {i}^{*} = ‖ {i}_{f}^{*} ‖ - ‖ {i}_{lim}^{*} ‖ ; \qquad ( 10 )$$

under normal operating conditions, Δi*=0. When a large disturbance caused by sudden phase angle changes occurs, the intermediate variable of the current instruction exceeds the maximum value of the overcurrent constraint. Therefore, the phase angle adaptive correction value is defined as:

Δω_{oc}=k_{wc}Δi*νⱼ_{_{q}} (11);

the q-axis component of the voltage νⱼ_{_{q}} at the grid connection point is obtained through coordinate transformation, which is expressed by a formula as follows:

$$[ \begin{matrix}{v}_{fd} \\ {v}_{fq}\end{matrix} ] = [ \begin{matrix}cos ( θ ) & sin ( θ ) \\ - sin ( θ ) & cos ( θ )\end{matrix} ] [ \begin{matrix}{v}_{f α} \\ {v}_{f β}\end{matrix} ] . \qquad ( 12 )$$

### (3) Establishing the Current Inner-Loop Control Model:

The current inner-loop control adopts a proportional resonant PR controller in a rotation coordinate system:

$$\frac{d}{dt} ξ = {ω}_{o} J ξ + {i}_{lim}^{*} - {i}_{f} ; \qquad ( 13 )$$

$${v}_{i} = {k}_{p} ( {i}_{lim}^{*} - {i}_{f} ) + {k}_{r} ξ + {v}_{f} + {ω}_{o} {L}_{f} {Ji}_{f} ; \qquad ( 14 )$$

where ξ represents an integral variable of a proportional resonant controller, and kₚ and kᵣ represent a proportional control parameter and a resonant integral control parameter, respectively. The inverter voltage instruction νᵢ directly controls the inverter node voltage through the PWM signal.

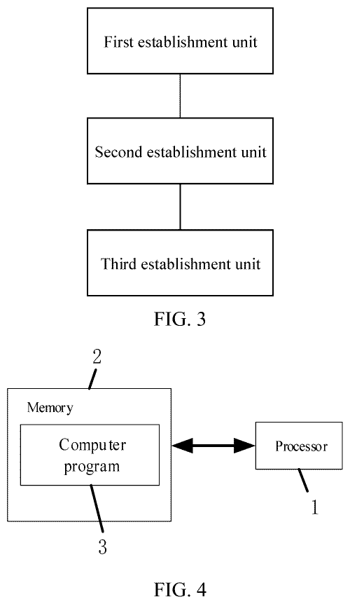

FIG. 3 is a block diagram of a photovoltaic energy storage grid-forming control system according to an exemplary embodiment of the present disclosure. As illustrated in FIG. 3, an exemplary embodiment of the present disclosure provides the photovoltaic energy storage grid-forming control system. The system includes: a first establishment unit configured to establish a full-state oscillator model and generate, by means of the full-state oscillator model, internal potential of a photovoltaic energy storage grid-forming power supply; a second establishment unit configured to establish a phase angle adaptive model and correct, by means of the phase angle adaptive model, the internal potential of the photovoltaic energy storage grid-forming power supply; and a third establishment unit configured to establish a current inner-loop control model and control, by means of the current inner-loop control model, stable operation of photovoltaic energy storage grid-forming based on corrected internal potential of the photovoltaic energy storage grid-forming power supply.

In an exemplary embodiment, expressions of the full-state oscillator model are:

$$\frac{d}{d \text{?}} {v}_{\text{?}} = {ω}_{\text{?}} {Jv}_{\text{?}} + η ( K {v}_{\text{?}} - R ( κ ) {i}_{\text{?}} + μϕ ( {v}_{\text{?}} , {v}_{\text{?}} ) {v}_{\text{?}} ) ; \qquad ( 1 )$$

$$K = \frac{1}{{v}_{\text{?}}^{* 2}} R ( κ ) [ \begin{matrix}{p}^{*} & {q}^{*} \\ - {q}^{*} & {p}^{*}\end{matrix} ] ; \qquad ( 2 )$$

$${ω}_{\text{?}} = {ω}_{\text{?}} + λ \cdot sin ( κ ) ( {v}_{\text{?}} - {v}_{\text{?}}^{\text{?}} ) + {Δω}_{\text{?}} ; \qquad ( 3 )$$

$$ϕ ( {v}_{\text{?}} , {v}_{\text{?}} ) = \frac{{v}_{\text{?}}^{\text{?}} - {v}_{\text{?}}}{{v}_{\text{?}}^{\text{?}}} + \frac{λ}{ημ} cos κ ( {v}_{\text{?}} - {v}_{\text{?}}^{\text{?}} ) ; \qquad ( 4 )$$

$$κ = {tan}^{- 1} ( {X}_{\text{?}} / {R}_{\text{?}} ) ; \qquad ( 5 )$$

$$R ( θ ) = [ \begin{matrix}cos θ & - sin θ \\ sin θ & cos θ\end{matrix} ] ; \qquad ( 6 )$$

$$\text{?} \text{indicates text missing or illegible when filed}$$

where: a vector νₒ=[ν_{oα} ν_{oβ}]^{T} represents a voltage of an oscillator, and ν_{oα} and ν_{oβ} represent α-axis and 3-axis components of the voltage of the oscillator, respectively; a vector iₒ=[i_{oα} i_{oβ}]^{T} represents an output current at a grid connection point, and i_{oα} and i_{oβ} represent α-axis and β-axis components of the output current at the grid connection point, respectively; ν_{dc} represents a voltage of a photovoltaic array or an energy storage battery at a direct current side; Δω_{oc} represents a phase angle adaptive correction value; R_{g} represents grid-connected resistance; X_{g} represents grid-connected reactance; θ represents a phase angle of the voltage of the oscillator; φ(νₘ, ν_{dc}) represents a control function of a voltage amplitude; K represents a power reference matrix; ωₒ represents a frequency setting value of the oscillator; η represents an active synchronization control parameter; μ represents an amplitude control parameter; λ represents a direct current voltage control parameter; νₘ=∥νₒ∥ represents an alternating current voltage amplitude, an operator ∥·∥ representing an Euclidean norm; p*, q*,

$${v}_{\text{?}}^{\text{?}} , and {v}_{\text{?}}^{\text{?}}$$

$$\text{?} \text{indicates text missing or illegible when filed}$$

represent setting values of active power, reactive power, a direct current voltage amplitude, and the alternating current voltage amplitude, respectively; ωₙ represents a rated frequency of a power grid; K represents a line impedance parameter angle; J=R(π/2) is defined; and a matrix R represents a two-dimensional rotation matrix.

In an exemplary embodiment, expressions of the phase angle adaptive model are:

$${i}_{\text{?}}^{\text{?}} = {Y}_{\text{?}} \cdot ( {v}_{\text{?}} - {v}_{f} ) ; \qquad ( 7 )$$

$${Y}_{\text{?}} = {Z}_{\text{?}}^{\text{?}} = {[ \begin{matrix}{R}_{\text{?}} & - {ω}_{\text{?}} {L}_{\text{?}} \\ {ω}_{\text{?}} {L}_{\text{?}} & {R}_{\text{?}}\end{matrix} ]}^{\text{?}} ; \qquad ( 8 )$$

$${i}_{\text{?}}^{*} = \{ \begin{matrix}{i}_{\text{?}}^{*} & ‖ {i}_{\text{?}}^{*} ‖ ⩽ {I}_{\text{?}} \\ \frac{{I}_{\text{?}}}{‖ {i}_{\text{?}}^{*} ‖} {i}_{\text{?}}^{*} & ‖ {i}_{\text{?}}^{*} ‖ > {I}_{\text{?}}\end{matrix} ; \qquad ( 9 )$$

$$Δ {i}^{*} = ‖ {i}_{f}^{*} ‖ - ‖ {i}_{lim}^{*} ‖ ; \qquad ( 10 )$$

$${Δω}_{\text{?}} = {k}_{\text{?}} Δ i * {v}_{\text{?}} ; \qquad ( 11 )$$

$$[ \begin{matrix}{v}_{\text{?}} \\ {v}_{\text{?}}\end{matrix} ] = [ \begin{matrix}cos ( θ ) & sin ( θ ) \\ - sin ( θ ) & cos ( θ )\end{matrix} ] [ \begin{matrix}{v}_{\text{?}} \\ {v}_{\text{?}}\end{matrix} ] ; \qquad ( 12 )$$

$$where : {i}_{f}^{*}$$

$$\text{?} \text{indicates text missing or illegible when filed}$$

represents an intermediate variable of an inverter current instruction; Y_{αβ} represents an inverse matrix of a virtual impedance matrix Z_{νi}; a vector νₒ=[ν_{oα} ν_{oβ}]^{T} represents a voltage of an oscillator; a vector ν_{f}=[ν_{fα} ν_{fβ}]^{T} represents a voltage measurement at a grid connection point, and ν_{fα} and ν_{fβ} represent α-axis and β-axis components of a voltage at the grid connection point, respectively; Rᵥ and Lᵥ represent virtual resistance and virtual inductance, respectively; ωₙ represents a rated frequency of a power grid; a vector

$${i}_{lim}^{*}$$

represents the inverter current instruction; Iₘₐₓ represents a maximum value of an overcurrent constraint; Δi* represents a degree of the overcurrent constraint; Δω_{oc} represents a phase angle adaptive correction value; k_{oc} represents a phase angle adaptive parameter; ν_{fq} represents a q-axis component of the voltage at the grid connection point; ν_{fd} represents a d-axis component of the voltage at the grid connection point; and θ represents a phase angle of the voltage of the oscillator.

In an exemplary embodiment, expressions of the current inner-loop control model are:

$$\frac{d}{d t} ξ = {ω}_{\text{?}} J ξ + {i}_{lim}^{*} - {i}_{\text{?}} ; \qquad ( 13 )$$

$${v}_{\text{?}} = {k}_{p} ( {i}_{lim}^{*} - {i}_{f} ) + {k}_{r} ξ + {v}_{\text{?}} + {ω}_{\text{?}} {L}_{\text{?}} J {i}_{\text{?}} ; \qquad ( 14 )$$

$$\text{?} \text{indicates text missing or illegible when filed}$$

where: ξ represents an integral variable of a proportional resonant controller, ωₒ represents a frequency setting value of an oscillator; a vector

$${i}_{lim}^{*}$$

represents an inverter current instruction; a vector i_{f}=[i_{jα} i_{jβ}]^{T} represents an output current of an inverter, and i_{fα} and i_{fβ} represent α-axis and β-axis components of the output current of the inverter, respectively; kₚ and kᵣ represent a proportional control parameter and a resonant integral control parameter, respectively; a vector ν_{f}=[ν_{jα} ν_{fβ}]^{T} represents a voltage measurement at a grid connection point, and ν_{fα} and ν_{fβ} represent α-axis and β-axis components of the voltage at the grid connection point, respectively; L_{f} represents a filter inductance; J=R(π/2) is defined; and a matrix R is a two-dimensional rotation matrix.

FIG. 4 is a schematic structural diagram of a device according to an exemplary embodiment of the present disclosure. As illustrated in FIG. 4, corresponding to the photovoltaic energy storage grid-forming control method provided above, the present disclosure also provides a device. Since the embodiments of this device are similar to the above-described method embodiments, the description is relatively simple. For related description, reference may be made to a corresponding part of the description of the method embodiments. The device described below is only illustrative. This device may include: a processor 1, a memory 2, a communication bus (i.e., the above-described device bus), and a search engine. The processor 1 and memory 2 communicate with each other via the communication bus and communicate with the outside via a communication interface. The processor 1 can invoke the logic instructions in the memory 2 to execute the photovoltaic energy storage grid-forming control method.

In addition, when the logical instruction in the above-described memory 2 can be implemented in the form of the software functional unit and be sold or used as a standalone product, it can be stored in a computer-readable storage medium. Based on this understanding, all or part of the technical solutions according to the embodiments of the present disclosure, or the part thereof that contributes to the prior art, can be embodied in the form of a software product. The computer software product may be stored in a storage medium and contain instructions to enable a computer device (which may be a personal computer, a server, a network device, or the like) to perform all or part of the steps of the method described in each of the embodiments of the present disclosure. The above-described storage medium includes various media capable of storing program codes, such as a memory chip, a universal serial bus (USB) flash disk, a removable hard disk, a read-only memory (ROM), a random access memory (RAM), a magnetic disk, or an optical disk.

On the other hand, an embodiment of the present disclosure further provides a processor-readable storage medium having a computer program 3 stored thereon. The computer program 3, when executed by the processor 1, implements and executes the photovoltaic energy storage grid-forming control method provided in the above-described embodiments.

The processor-readable storage medium may be any available medium or data storage device that can be accessed by the processor 1, including but not limited to magnetic memories (such as a floppy disk, a hard disk, a magnetic tape, and a magneto-optical disk (MO)), optical memories (such as a CD, a DVD, a BD, and a HVD), and semiconductor memories (such as a ROM, a EPROM, a EEPROM, a non-volatile memory (NANDFLASH), and a solid state drive (SSD)), etc.

While exemplary embodiments of the present disclosure are described above, the protection scope of the present disclosure is not limited to the above-described embodiments; all technical solutions falling under the idea of the present disclosure shall be within the protection scope of the present disclosure. It should be noted that, various improvements and modifications can be made by those skilled in the art without departing from the principle of the present disclosure. These improvements and modifications are to be encompassed by the protect scope of present disclosure.

What is claimed is:

1. A photovoltaic energy storage grid-forming control method, comprising:
establishing a full-state oscillator model, and generating, by means of the full-state oscillator model, internal potential of a photovoltaic energy storage grid-forming power supply;
establishing a phase angle adaptive model, and correcting, by means of the phase angle adaptive model, the internal potential of the photovoltaic energy storage grid-forming power supply; and
establishing a current inner-loop control model, and controlling, by means of the current inner-loop control model, stable operation of photovoltaic energy storage grid-forming based on corrected internal potential of the photovoltaic energy storage grid-forming power supply.

2. The photovoltaic energy storage grid-forming control method according to claim 1, wherein expressions of the full-state oscillator model are:
$$\frac{d}{d \text{?}} {v}_{\text{?}} = {ω}_{\text{?}} {Jv}_{\text{?}} + η ( K {v}_{\text{?}} - R ( κ ) {i}_{\text{?}} + μϕ ( {v}_{\text{?}} , {v}_{\text{?}} ) {v}_{\text{?}} ) ; \qquad ( 1 )$$
$$K = \frac{1}{{v}_{\text{?}}^{* 2}} R ( κ ) [ \begin{matrix}{p}^{*} & {q}^{*} \\ - {q}^{*} & {p}^{*}\end{matrix} ] ; \qquad ( 2 )$$
$${ω}_{\text{?}} = {ω}_{\text{?}} + λ \cdot sin ( κ ) ( {v}_{\text{?}} - {v}_{\text{?}}^{\text{?}} ) + {Δω}_{\text{?}} ; \qquad ( 3 )$$
$$ϕ ( {v}_{\text{?}} , {v}_{\text{?}} ) = \frac{{v}_{\text{?}}^{\text{?}} - {v}_{\text{?}}}{{v}_{\text{?}}^{\text{?}}} + \frac{λ}{ημ} cos κ ( {v}_{\text{?}} - {v}_{\text{?}}^{\text{?}} ) ; \qquad ( 4 )$$
$$κ = {tan}^{- 1} ( {X}_{\text{?}} / {R}_{\text{?}} ) ; \qquad ( 5 )$$
$$R ( θ ) = [ \begin{matrix}cos θ & - sin θ \\ sin θ & cos θ\end{matrix} ] ; \qquad ( 6 )$$
$$\text{?} \text{indicates text missing or illegible when filed}$$
where: a vector νₒ=[ν_{oα} ν_{oβ}]^{T} represents a voltage of an oscillator, and ν_{oα} and ν_{oβ} represent α-axis and β-axis components of the voltage of the oscillator, respectively; a vector iₒ=[i_{oα} i_{oβ}]^{T} represents an output current at a grid connection point, and i_{oα} and i_{oβ} represent α-axis and β-axis components of the output current at the grid connection point, respectively; ν_{dc} represents a voltage of a photovoltaic array or an energy storage battery at a direct current side; Δω_{oc} represents a phase angle adaptive correction value; R_{g} represents grid-connected resistance; X_{g} represents grid-connected reactance; θ represents a phase angle of the voltage of the oscillator; φ(νₘ, ν_{dc}) represents a control function of a voltage amplitude; K represents a power reference matrix; ωₒ represents a frequency setting value of the oscillator; η represents an active synchronization control parameter; μ represents an amplitude control parameter; λ represents a direct current voltage control parameter; νₘ=∥νₒ∥ represents an alternating current voltage amplitude, an operator ∥·∥ representing an Euclidean norm; p*, q*,
$${v}_{\text{?}}^{\text{?}} , and {v}_{\text{?}}^{\text{?}}$$
$$\text{?} \text{indicates text missing or illegible when filed}$$
represent setting values of active power, reactive power, a direct current voltage amplitude, and the alternating current voltage amplitude, respectively; ωₙ represents a rated frequency of a power grid; K represents a line impedance parameter angle; J=R(π/2) is defined; and a matrix R represents a two-dimensional rotation matrix.

3. The photovoltaic energy storage grid-forming control method according to claim 1, wherein expressions of the phase angle adaptive model are:
$${i}_{\text{?}}^{\text{?}} = {Y}_{\text{?}} \cdot ( {v}_{\text{?}} - {v}_{f} ) ; \qquad ( 7 )$$
$${Y}_{\text{?}} = {Z}_{\text{?}}^{\text{?}} = {[ \begin{matrix}{R}_{\text{?}} & - {ω}_{\text{?}} {L}_{\text{?}} \\ {ω}_{\text{?}} {L}_{\text{?}} & {R}_{\text{?}}\end{matrix} ]}^{\text{?}} ; \qquad ( 8 )$$
$${i}_{\text{?}}^{*} = \{ \begin{matrix}{i}_{\text{?}}^{*} & ‖ {i}_{\text{?}}^{*} ‖ ⩽ {I}_{\text{?}} \\ \frac{{I}_{\text{?}}}{‖ {i}_{\text{?}}^{*} ‖} {i}_{\text{?}}^{*} & ‖ {i}_{\text{?}}^{*} ‖ > {I}_{\text{?}}\end{matrix} ; \qquad ( 9 )$$
$$Δ {i}^{*} = ‖ {i}_{f}^{*} ‖ - ‖ {i}_{lim}^{*} ‖ ; \qquad ( 10 )$$
$${Δω}_{\text{?}} = {k}_{\text{?}} Δ i * {v}_{\text{?}} ; \qquad ( 11 )$$
$$[ \begin{matrix}{v}_{\text{?}} \\ {v}_{\text{?}}\end{matrix} ] = [ \begin{matrix}cos ( θ ) & sin ( θ ) \\ - sin ( θ ) & cos ( θ )\end{matrix} ] [ \begin{matrix}{v}_{\text{?}} \\ {v}_{\text{?}}\end{matrix} ] ; \qquad ( 12 )$$
$$where : {i}_{f}^{*}$$
$$\text{?} \text{indicates text missing or illegible when filed}$$
represents an intermediate variable of an inverter current instruction; Y_{oβ} represents an inverse matrix of a virtual impedance matrix Z_{νi}; a vector νₒ=[ν_{oα} ν_{oβ}]^{T} represents a voltage of an oscillator; a vector ν_{f}=[ν_{fα} ν_{fβ}]^{T} represents a voltage measurement at a grid connection point, and ν_{fα} and ν_{fβ} represent α-axis and β-axis components of a voltage at the grid connection point, respectively; Rᵥ and Lᵥ represent virtual resistance and virtual inductance, respectively; ωₙ represents a rated frequency of a power grid; a vector
$${i}_{lim}^{*}$$
represents the inverter current instruction; Iₘₐₓ represents a maximum value of an overcurrent constraint; Δi* represents a degree of the overcurrent constraint; Δω_{oc} represents a phase angle adaptive correction value; k_{oc} represents a phase angle adaptive parameter; ν_{fq} represents a q-axis component of the voltage at the grid connection point; ν_{jd} represents a d-axis component of the voltage at the grid connection point; and θ represents a phase angle of the voltage of the oscillator.

4. The photovoltaic energy storage grid-forming control method according to claim 1, wherein expressions of the current inner-loop control model are:
$$\frac{d}{d t} ξ = {ω}_{\text{?}} J ξ + {i}_{lim}^{*} - {i}_{\text{?}} ; \qquad ( 13 )$$
$${v}_{\text{?}} = {k}_{p} ( {i}_{lim}^{*} - {i}_{f} ) + {k}_{r} ξ + {v}_{\text{?}} + {ω}_{\text{?}} {L}_{\text{?}} J {i}_{\text{?}} ; \qquad ( 14 )$$
$$\text{?} \text{indicates text missing or illegible when filed}$$
where ξ represents an integral variable of a proportional resonant controller, ωₒ represents a frequency setting value of an oscillator; a vector
$${i}_{lim}^{*}$$
represents an inverter current instruction; a vector i_{f}=[i_{jα} i_{jβ}]^{T} represents an output current of an inverter, and i_{fα} and i_{fβ} represent α-axis and β-axis components of the output current of the inverter, respectively; kₚ and kᵣ represent a proportional control parameter and a resonant integral control parameter, respectively; a vector ν_{f}=[ν_{fα} ν_{fβ}]^{T} represents a voltage measurement at a grid connection point, and ν_{fα} and ν_{fβ} represent α-axis and β-axis components of the voltage at the grid connection point, respectively; L_{f} represents a filter inductance; J=R(π/2) is defined; and a matrix R is a two-dimensional rotation matrix.

5. A photovoltaic energy storage grid-forming control system, comprising:
a first establishment unit configured to establish a full-state oscillator model and generate, by means of the full-state oscillator model, internal potential of a photovoltaic energy storage grid-forming power supply;
a second establishment unit configured to establish a phase angle adaptive model and correct, by means of the phase angle adaptive model, the internal potential of the photovoltaic energy storage grid-forming power supply; and
a third establishment unit configured to establish a current inner-loop control model and control, by means of the current inner-loop control model, stable operation of photovoltaic energy storage grid-forming based on corrected internal potential of the photovoltaic energy storage grid-forming power supply.

6. The photovoltaic energy storage grid-forming control system according to claim 5, wherein expressions of the full-state oscillator model are:
$$\frac{d}{d \text{?}} {v}_{\text{?}} = {ω}_{\text{?}} {Jv}_{\text{?}} + η ( K {v}_{\text{?}} - R ( κ ) {i}_{\text{?}} + μϕ ( {v}_{\text{?}} , {v}_{\text{?}} ) {v}_{\text{?}} ) ; \qquad ( 1 )$$
$$K = \frac{1}{{v}_{\text{?}}^{* 2}} R ( κ ) [ \begin{matrix}{p}^{*} & {q}^{*} \\ - {q}^{*} & {p}^{*}\end{matrix} ] ; \qquad ( 2 )$$
$${ω}_{\text{?}} = {ω}_{\text{?}} + λ \cdot sin ( κ ) ( {v}_{\text{?}} - {v}_{\text{?}}^{\text{?}} ) + {Δω}_{\text{?}} ; \qquad ( 3 )$$
$$ϕ ( {v}_{\text{?}} , {v}_{\text{?}} ) = \frac{{v}_{\text{?}}^{\text{?}} - {v}_{\text{?}}}{{v}_{\text{?}}^{\text{?}}} + \frac{λ}{ημ} cos κ ( {v}_{\text{?}} - {v}_{\text{?}}^{\text{?}} ) ; \qquad ( 4 )$$
$$κ = {tan}^{- 1} ( {X}_{\text{?}} / {R}_{\text{?}} ) ; \qquad ( 5 )$$
$$R ( θ ) = [ \begin{matrix}cos θ & - sin θ \\ sin θ & cos θ\end{matrix} ] ; \qquad ( 6 )$$
$$\text{?} \text{indicates text missing or illegible when filed}$$
where: a vector νₒ=[ν_{mα} ν_{mβ}]^{T} represents a voltage of an oscillator, and ν_{oα} and ν_{oβ} represent α-axis and β-axis components of the voltage of the oscillator, respectively; a vector iₒ=[i_{oα} i_{oβ}]^{T} represents an output current at a grid connection point, and i_{oα} and i_{oβ} represent α-axis and β-axis components of the output current at the grid connection point, respectively; ν_{dc} represents a voltage of a photovoltaic array or an energy storage battery at a direct current side; Δω_{oc} represents a phase angle adaptive correction value; R_{g} represents grid-connected resistance; X_{g} represents grid-connected reactance; θ represents a phase angle of the voltage of the oscillator; φ(νₘ, ν_{dc}) represents a control function of a voltage amplitude; K represents a power reference matrix; ωₒ represents a frequency setting value of the oscillator; η represents an active synchronization control parameter; μ represents an amplitude control parameter; λ represents a direct current voltage control parameter; νₘ=∥νₒ∥ represents an alternating current voltage amplitude, an operator ∥·∥ representing an Euclidean norm; p*, q*,
$${v}_{dc}^{*} , and {v}_{m}^{*}$$
represent setting values of active power, reactive power, a direct current voltage amplitude, and the alternating current voltage amplitude, respectively; ωₙ represents a rated frequency of a power grid; K represents a line impedance parameter angle; J=R(π/2) is defined; and a matrix R represents a two-dimensional rotation matrix.

7. The photovoltaic energy storage grid-forming control system according to claim 5, wherein expressions of the phase angle adaptive model are:
$${i}_{\text{?}}^{\text{?}} = {Y}_{\text{?}} \cdot ( {v}_{\text{?}} - {v}_{f} ) ; \qquad ( 7 )$$
$${Y}_{\text{?}} = {Z}_{\text{?}}^{\text{?}} = {[ \begin{matrix}{R}_{\text{?}} & - {ω}_{\text{?}} {L}_{\text{?}} \\ {ω}_{\text{?}} {L}_{\text{?}} & {R}_{\text{?}}\end{matrix} ]}^{\text{?}} ; \qquad ( 8 )$$
$${i}_{\text{?}}^{*} = \{ \begin{matrix}{i}_{\text{?}}^{*} & ‖ {i}_{\text{?}}^{*} ‖ ⩽ {I}_{\text{?}} \\ \frac{{I}_{\text{?}}}{‖ {i}_{\text{?}}^{*} ‖} {i}_{\text{?}}^{*} & ‖ {i}_{\text{?}}^{*} ‖ > {I}_{\text{?}}\end{matrix} ; \qquad ( 9 )$$
$$Δ {i}^{*} = ‖ {i}_{f}^{*} ‖ - ‖ {i}_{lim}^{*} ‖ ; \qquad ( 10 )$$
$${Δω}_{\text{?}} = {k}_{\text{?}} Δ i * {v}_{\text{?}} ; \qquad ( 11 )$$
$$[ \begin{matrix}{v}_{\text{?}} \\ {v}_{\text{?}}\end{matrix} ] = [ \begin{matrix}cos ( θ ) & sin ( θ ) \\ - sin ( θ ) & cos ( θ )\end{matrix} ] [ \begin{matrix}{v}_{\text{?}} \\ {v}_{\text{?}}\end{matrix} ] ; \qquad ( 12 )$$
$$where : {i}_{f}^{*}$$
$$\text{?} \text{indicates text missing or illegible when filed}$$
represents an intermediate variable of an inverter current instruction; Y_{αβ} represents an inverse matrix of a virtual impedance matrix Z_{νi}; a vector νₒ=[ν_{oα} ν_{oβ}]^{T} represents a voltage of an oscillator; a vector νⱼ=[ν_{fα} ν_{fβ}]^{T} represents a voltage measurement at a grid connection point, and ν_{fα} and ν_{fβ} represent α-axis and β-axis components of a voltage at the grid connection point, respectively; Rᵥ and Lᵥ represent virtual resistance and virtual inductance, respectively; ωₙ represents a rated frequency of a power grid; a vector
$${i}_{lim}^{*}$$
represents the inverter current instruction; Iₘₐₓ represents a maximum value of an overcurrent constraint; Δi* represents a degree of the overcurrent constraint; Δω_{oc} represents a phase angle adaptive correction value; k_{oc} represents a phase angle adaptive parameter; ν_{fq} represents a q-axis component of the voltage at the grid connection point; ν_{fd} represents a d-axis component of the voltage at the grid connection point; and θ represents a phase angle of the voltage of the oscillator.

8. The photovoltaic energy storage grid-forming control system according to claim 5, wherein expressions of the current inner-loop control model are:
$$\frac{d}{dt} ξ = {ω}_{o} J ξ + {i}_{lim}^{*} - {i}_{f} ; \qquad ( 13 )$$
$${v}_{i} = {k}_{p} ( {i}_{lim}^{*} - {i}_{f} ) + {k}_{r} ξ + {v}_{f} + {ω}_{o} {L}_{f} J {i}_{f} ; \qquad ( 14 )$$
where: ξ represents an integral variable of a proportional resonant controller, ωₒ represents a frequency setting value of an oscillator; a vector
$${i}_{lim}^{*}$$
represents an inverter current instruction; a vector iⱼ=[i_{fα}, i_{jβ}]^{T} represents an output current of an inverter, and i_{fα} and i_{jβ} represent α-axis and β-axis components of the output current of the inverter, respectively; kₚ and kᵣ represent a proportional control parameter and a resonant integral control parameter, respectively; a vector ν_{f}=[ν_{fα}, ν_{jβ}]^{T} represents a voltage measurement at a grid connection point, and ν_{fα} and ν_{jβ} represent α-axis and β-axis components of the voltage at the grid connection point, respectively; L_{f} represents a filter inductance; J=R(π/2) is defined; and a matrix R is a two-dimensional rotation matrix.

9. A device, comprising:
a processor; and
a memory configured to store a computer program, wherein the processor invokes the computer program stored in the memory to perform a photovoltaic energy storage grid-forming control method, the method comprising:
establishing a full-state oscillator model, and generating, by means of the full-state oscillator model, internal potential of a photovoltaic energy storage grid-forming power supply;
establishing a phase angle adaptive model, and correcting, by means of the phase angle adaptive model, the internal potential of the photovoltaic energy storage grid-forming power supply; and
establishing a current inner-loop control model, and controlling, by means of the current inner-loop control model, stable operation of photovoltaic energy storage grid-forming based on corrected internal potential of the photovoltaic energy storage grid-forming power supply.

10. The device according to claim 9, wherein expressions of the full-state oscillator model are:
$$\frac{d}{dt} {v}_{\text{?}} = {ω}_{\text{?}} J {v}_{\text{?}} + ζ ( K {v}_{\text{?}} - R ( κ ) {i}_{\text{?}} μϕ ( {v}_{\text{?}} {v}_{\text{?}} ) {v}_{\text{?}} ) ; \qquad ( 1 )$$
$$K = \frac{1}{{v}_{m}^{\text{?} 2}} R ( κ ) [ \begin{matrix}{p}^{*} & {q}^{*} \\ - {q}^{*} & {p}^{*}\end{matrix} ] ; \qquad ( 2 )$$
$${ω}_{o} = {ω}_{\text{?}} + λ \cdot sin ( κ ) ( {v}_{dc} - {v}_{dc}^{*} ) + {Δω}_{\text{?}} ; \qquad ( 3 )$$
$$ϕ ( {v}_{m} , {v}_{dc} ) = \frac{{v}_{m}^{\text{?}} - {v}_{m}}{{v}_{m}^{\text{?}}} + \frac{λ}{ημ} cos κ ( {v}_{\text{?}} - {v}_{dc}^{*} ) ; \qquad ( 4 )$$
$$κ = {tan}^{- 1} ( {X}_{\text{?}} / {R}_{\text{?}} ) ; \qquad ( 5 )$$
$$R ( θ ) = [ \begin{matrix}cos θ & - sin θ \\ sin θ & cos θ\end{matrix} ] ; \qquad ( 6 )$$
$$\text{?} \text{indicates text missing or illegible when filed}$$
where: a vector νₒ=[ν_{oα} ν_{oβ}]^{T} represents a voltage of an oscillator, and ν_{oα} and ν_{oβ} represent α-axis and β-axis components of the voltage of the oscillator, respectively; a vector iₒ=[i_{oα} i_{oβ}]^{T} represents an output current at a grid connection point, and i_{oα} i_{oβ} and represent α-axis and β-axis components of the output current at the grid connection point, respectively; ν_{dc} represents a voltage of a photovoltaic array or an energy storage battery at a direct current side; Δω_{oc} represents a phase angle adaptive correction value; R_{g} represents grid-connected resistance; X_{g} represents grid-connected reactance; θ represents a phase angle of the voltage of the oscillator; φ(νₘ, ν_{dc}) represents a control function of a voltage amplitude; K represents a power reference matrix; ωₒ represents a frequency setting value of the oscillator; η represents an active synchronization control parameter; μ represents an amplitude control parameter; λ represents a direct current voltage control parameter; νₘ=∥νₒ∥ represents an alternating current voltage amplitude, an operator ∥·∥ representing an Euclidean norm; p*, q*,
$${v}_{dc}^{*} , and {v}_{m}^{*}$$
represent setting values of active power, reactive power, a direct current voltage amplitude, and the alternating current voltage amplitude, respectively; ωₙ represents a rated frequency of a power grid; K represents a line impedance parameter angle; J=R(π/2) is defined; and a matrix R represents a two-dimensional rotation matrix.

11. The device according to claim 9, wherein expressions of the phase angle adaptive model are:
$${i}_{f}^{*} = {Y}_{\text{?}} \cdot ( {v}_{\text{?}} - {v}_{\text{?}} ) ; \qquad ( 7 )$$
$${Y}_{\text{?}} = {Z}_{\text{?}}^{- 1} = {[ \begin{matrix}{R}_{\text{?}} & - {ω}_{\text{?}} {L}_{\text{?}} \\ {ω}_{\text{?}} {L}_{\text{?}} & {R}_{\text{?}}\end{matrix} ]}^{- 1} ; \qquad ( 8 )$$
$${i}_{lim}^{*} = \{ \begin{matrix}{i}_{\text{?}}^{\text{?}} & ‖ {i}_{f}^{*} ‖ ⩽ {I}_{max} \\ \frac{{I}_{max}}{‖ {i}_{f}^{*} ‖} {i}_{f}^{*} & ‖ {i}_{f}^{*} ‖ > {I}_{max}\end{matrix} ; \qquad ( 9 )$$
$$Δ {i}^{*} = ‖ {i}_{f}^{*} ‖ - ‖ {i}_{lim}^{*} ‖ ; \qquad ( 10 )$$
$$Δ {ω}_{\text{?}} = {k}_{\text{?}} Δ {i}^{*} {v}_{\text{?}} ; \qquad ( 11 )$$
$$[ \begin{matrix}{v}_{\text{?}} \\ {v}_{\text{?}}\end{matrix} ] = [ \begin{matrix}cos ( θ ) & sin ( θ ) \\ - sin ( θ ) & cos ( θ )\end{matrix} ] [ \begin{matrix}{v}_{\text{?}} \\ {v}_{\text{?}}\end{matrix} ] ; \qquad ( 12 )$$
$$where : {i}_{f}^{*}$$
$$\text{?} \text{indicates text missing or illegible when filed}$$
represents an intermediate variable of an inverter current instruction; Y_{αβ} represents an inverse matrix of a virtual impedance matrix Z_{νi}; a vector νₒ=[ν_{oα} ν_{oβ}]^{T} represents a voltage of an oscillator; a vector νⱼ=[ν_{fα} ν_{fβ}]^{T} represents a voltage measurement at a grid connection point, and ν_{fα} and ν_{fβ} represent α-axis and β-axis components of a voltage at the grid connection point, respectively; Rᵥ and Lᵥ represent virtual resistance and virtual inductance, respectively; ωₙ represents a rated frequency of a power grid; a vector
$${i}_{lim}^{*}$$
represents the inverter current instruction; Iₘₐₓ represents a maximum value of an overcurrent constraint; Δi* represents a degree of the overcurrent constraint; Δω_{oc} represents a phase angle adaptive correction value; k_{oc} represents a phase angle adaptive parameter; ν_{fq} represents a q-axis component of the voltage at the grid connection point; ν_{fd} represents a d-axis component of the voltage at the grid connection point; and θ represents a phase angle of the voltage of the oscillator.

12. The device according to claim 9, wherein expressions of the current inner-loop control model are:
$$\frac{d}{dt} ξ = {ω}_{o} J ξ + {i}_{lim}^{*} - {i}_{f} ; \qquad ( 13 )$$
$${v}_{i} = {k}_{p} ( {i}_{lim}^{*} - {i}_{f} ) + {k}_{r} ξ + {v}_{f} + {ω}_{o} {L}_{f} J {i}_{f} ; \qquad ( 14 )$$
where: ξ represents an integral variable of a proportional resonant controller, ωₒ represents a frequency setting value of an oscillator; a vector
$${i}_{lim}^{*}$$
represents an inverter current instruction; a vector i_{f}=[i_{fα} i_{fβ}]^{T} represents an output current of an inverter, and i_{fα} and i_{fβ} represent α-axis and β-axis components of the output current of the inverter, respectively; kₚ and kᵣ represent a proportional control parameter and a resonant integral control parameter, respectively; a vector ν_{f}=[ν_{fα} ν_{fβ}]^{T} represents a voltage measurement at a grid connection point, and ν_{fα} and ν_{fβ} represent α-axis and β-axis components of the voltage at the grid connection point, respectively; L_{f} represents a filter inductance; J=R(π/2) is defined; and a matrix R is a two-dimensional rotation matrix.

13. A computer-readable storage medium having a computer program stored thereon, wherein the computer program, when executed by a processor, allows the processor to be capable of performing the photovoltaic energy storage grid-forming control method according to claim 1.

14. The computer-readable storage medium according to claim 13, wherein expressions of the full-state oscillator model are:
$$\frac{d}{dt} {v}_{\text{?}} = {ω}_{\text{?}} J {v}_{\text{?}} + ζ ( K {v}_{\text{?}} - R ( κ ) {i}_{\text{?}} μϕ ( {v}_{\text{?}} {v}_{\text{?}} ) {v}_{\text{?}} ) ; \qquad ( 1 )$$
$$K = \frac{1}{{v}_{m}^{\text{?} 2}} R ( κ ) [ \begin{matrix}{p}^{*} & {q}^{*} \\ - {q}^{*} & {p}^{*}\end{matrix} ] ; \qquad ( 2 )$$
$${ω}_{o} = {ω}_{\text{?}} + λ \cdot sin ( κ ) ( {v}_{dc} - {v}_{dc}^{*} ) + {Δω}_{\text{?}} ; \qquad ( 3 )$$
$$ϕ ( {v}_{\text{?}} , {v}_{\text{?}} ) = \frac{{v}_{\text{?}}^{} - {v}_{\text{?}}}{{v}_{\text{?}}^{\text{?}}} + \frac{λ}{ημ} cos κ ( {v}_{\text{?}} - {v}_{\text{?}}^{*} ) ; \qquad ( 4 )$$
$$κ = {tan}^{- 1} ( {X}_{\text{?}} / {R}_{\text{?}} ) ; \qquad ( 5 )$$
$$R ( θ ) = [ \begin{matrix}cos θ & - sin θ \\ sin θ & cos θ\end{matrix} ] ; \qquad ( 6 )$$
$$\text{?} \text{indicates text missing or illegible when filed}$$
where: a vector νₒ=[ν_{oα} ν_{oβ}]^{T} represents a voltage of an oscillator, and ν_{oα} and ν_{oβ} represent α-axis and β-axis components of the voltage of the oscillator, respectively; a vector iₒ=[i_{oα} i_{oβ}]^{T} represents an output current at a grid connection point, and i_{oα} and i_{oβ} represent α-axis and β-axis components of the output current at the grid connection point, respectively; ν_{dc} represents a voltage of a photovoltaic array or an energy storage battery at a direct current side; Δω_{oc} represents a phase angle adaptive correction value; R_{g} represents grid-connected resistance; X_{g} represents grid-connected reactance; θ represents a phase angle of the voltage of the oscillator; φ(νₘ, ν_{dc}) represents a control function of a voltage amplitude; K represents a power reference matrix; ω^{o} represents a frequency setting value of the oscillator; η represents an active synchronization control parameter; μ represents an amplitude control parameter; λ represents a direct current voltage control parameter; νₘ=∥νₒ∥ represents an alternating current voltage amplitude, an operator ∥·∥ representing an Euclidean norm; p*, q*,
$${v}_{dc}^{*} , and {v}_{m}^{*}$$
represent setting values of active power, reactive power, a direct current voltage amplitude, and the alternating current voltage amplitude, respectively; ωₙ represents a rated frequency of a power grid; K represents a line impedance parameter angle; J=R(π/2) is defined; and a matrix R represents a two-dimensional rotation matrix.

15. The computer-readable storage medium according to claim 13, wherein expressions of the phase angle adaptive model are:
$${i}_{f}^{*} = {Y}_{\text{?}} \cdot ( {v}_{\text{?}} - {v}_{\text{?}} ) ; \qquad ( 7 )$$
$${Y}_{\text{?}} = {Z}_{\text{?}}^{- 1} = {[ \begin{matrix}{R}_{\text{?}} & - {ω}_{\text{?}} {L}_{\text{?}} \\ {ω}_{\text{?}} {L}_{\text{?}} & {R}_{\text{?}}\end{matrix} ]}^{- 1} ; \qquad ( 8 )$$
$${i}_{lim}^{*} = \{ \begin{matrix}{i}_{\text{?}}^{\text{?}} & ‖ {i}_{f}^{*} ‖ ⩽ {I}_{\text{?}} \\ \frac{{I}_{\text{?}}}{‖ {i}_{f}^{*} ‖} {i}_{f}^{*} & ‖ {i}_{f}^{*} ‖ > {I}_{\text{?}}\end{matrix} ; \qquad ( 9 )$$
$$\begin{matrix}Δ {i}^{*} = ‖ {i}_{f}^{*} ‖ - ‖ {i}_{lim}^{*} ‖ ; & ( 10 )\end{matrix}$$
$$Δ {ω}_{\text{?}} = {k}_{\text{?}} Δ {i}^{*} {v}_{\text{?}} ; \qquad ( 11 )$$
$$[ \begin{matrix}{v}_{\text{?}} \\ {v}_{\text{?}}\end{matrix} ] = [ \begin{matrix}cos ( θ ) & sin ( θ ) \\ - sin ( θ ) & cos ( θ )\end{matrix} ] [ \begin{matrix}{v}_{\text{?}} \\ {v}_{\text{?}}\end{matrix} ] ; \qquad ( 12 )$$
$$where : {i}_{f}^{*}$$
$$\text{?} \text{indicates text missing or illegible when filed}$$
represents an intermediate variable of an inverter current instruction; Y_{αβ} represents an inverse matrix of a virtual impedance matrix Z_{νi}; a vector νₒ=[ν_{oα} ν_{oβ}]^{T} represents a voltage of an oscillator; a vector νⱼ=[ν_{fα} ν_{fβ}]^{T} represents a voltage measurement at a grid connection point, and ν_{fα} and ν_{fβ} represent α-axis and β-axis components of a voltage at the grid connection point, respectively; Rᵥ and Lᵥ represent virtual resistance and virtual inductance, respectively; ωₙ represents a rated frequency of a power grid; a vector
$${i}_{lim}^{*}$$
represents the inverter current instruction; Iₘₐₓ represents a maximum value of an overcurrent constraint; Δi* represents a degree of the overcurrent constraint; Δω_{oc} represents a phase angle adaptive correction value; k_{oc} represents a phase angle adaptive parameter; ν_{fq} represents a q-axis component of the voltage at the grid connection point; ν_{fd} represents a d-axis component of the voltage at the grid connection point; and θ represents a phase angle of the voltage of the oscillator.

16. The computer-readable storage medium according to claim 13, wherein expressions of the current inner-loop control model are:
$$\frac{d}{dt} ξ = {ω}_{o} J ξ + {i}_{lim}^{*} - {i}_{f} ; \qquad ( 13 )$$
$${v}_{i} = {k}_{p} ( {i}_{lim}^{*} - {i}_{f} ) + {k}_{r} ξ + {v}_{f} + {ω}_{o} {L}_{f} J {i}_{f} ; \qquad ( 14 )$$
where: ξ represents an integral variable of a proportional resonant controller, ωₒ represents a frequency setting value of an oscillator; a vector
$${i}_{lim}^{*}$$
represents an inverter current instruction; a vector i_{f}=[i_{fα}, i_{fβ}]^{T} represents an output current of an inverter, and i_{fα} and i_{fβ} represent α-axis and β-axis components of the output current of the inverter, respectively; kₚ and kᵣ represent a proportional control parameter and a resonant integral control parameter, respectively; a vector ν_{f}=[ν_{fα} ν_{fβ}]^{T} represents a voltage measurement at a grid connection point, and ν_{fα} and ν_{fβ} represent α-axis and β-axis components of the voltage at the grid connection point, respectively; L_{f} represents a filter inductance; J=R(π/2) is defined; and a matrix R is a two-dimensional rotation matrix.
